(19) United States
(12) Patent Application Publication
(10) Pub. No.: US 2018/0197135 A1
(43) Pub. Date: Jul. 12, 2018

(54) Apparatus and System For Remote Sensing, Monitoring, Analysis and Alerting of Environmental Attributes

(71) Applicant: Hillside Equity, Inc., Bethlehem, PA (US)

(72) Inventors: Jared Moyer, Bethlehem, PA (US); Joshua Brent Moyer, Bethlehem, PA (US); Ryan David Dunlevy, Hellertown, PA (US); Alexander Joseph Burdine, Emmaus, PA (US)

(73) Assignee: Hillside Equity, Inc., Bethlehem, PA (US)

(21) Appl. No.: 15/759,274

(22) PCT Filed: Sep. 11, 2016
(86) PCT No.: PCT/US16/51201

§ 371 Date: Mar. 12, 2018

Related U.S. Application Data
(60) Provisional application No. 62/217,485, filed on Sep. 11, 2015.

(51) Int. Cl. G06Q 10/08; G06K 19/07

(52) U.S. Cl. CPC G06Q 10/087; G06K 19/0717

(57) ABSTRACT

A system and apparatus for measuring, monitoring, and/or controlling environmental attributes of various goods, particularly as the goods move along the supply chain from an originator to the ultimate consumer. One or more databases of historic environmental data may be created, integrated and compared—which may also include information defining the various geographic locations where the goods were stored along the journey from “farm to table”. The databases of historical environmental data may be supplemented and integrated with other sources of information to assist in better product usage and less waste. In one form, the system is passive and consists of collecting the information; in another, the system is active and is capable of adjusting various environmental parameters. Various devices are also described that may be used by consumers or commercial entities.

### CROSS-REFERENCE TO RELATED APPLICATIONS

This application claims the benefit of U.S. Provisional Application Ser. No. 62/217,485, filed Sep. 11, 2015 and herein incorporated by reference.

### TECHNICAL FIELD

The present invention relates to an apparatus and system for remote sensing, monitoring, analyzing, altering and possibly controlling of environmental attributes associated with items along the path from production to consumption and, more particularly, to an apparatus and system that may be utilized to provide additional information to both consumers and industries regarding the acceptable qualities of these items based on collected environmental attribute history.

### BACKGROUND OF THE INVENTION

Beverages and foodstuffs (hereinafter referred to as “perishables” for the sake of convenience) are often consumed uncomfortably hot or cold, and/or are unintentionally overcooked or undercooked . This may result in wasted energies (including utilities such as electric/gas, and physical, mental, and emotional energies), wasted food and time, ruined meals, and possible food-borne illness (since many people do not have or regularly use any technology such as thermometers during—or at any times after—cooking and/or before eating or drinking). Various other produced items (i.e., non-perishables) may often suffer a decrease in quality as a result of exposure to certain environmental conditions along the path from the producer to the consumer.

Many rooms and/or spaces within homes, offices, and other environments such as cars lack any accurate localized environmental sensors such as temperature gauges, gas sensors, etc. Additionally, many commercial establishments include certain specific areas within their distribution chains and/or manufacturing facilities where it is difficult to control or even “know” various environmental conditions on an on-going basis. These specific areas include, but are not limited to, near certain critical machine parts, or specific spaces or places within warehouses or parts of a transportation system such as shipping containers on cargo ships, railroad cars, trucks, or airplanes.

Both individual consumers and businesses have widely varying preferences on the temperatures and/or other environmental conditions at which they like their beverages, foods, ingredients and items (including both raw commodities/ingredients and finished goods), and environments that may surround employees or any machines or inventory to be served, set, or stored in inventory. For example, some businesses may have a corporate goal to minimize energy expenses or environment impact of their operations; other businesses may strive to deliver super-premium quality goods, and accept increased HVAC or energy costs in order to maintain their goods in optimal condition as a necessary cost of doing business that yields differentiated products and a competitive advantage in the marketplace.

Moreover, some individuals and businesses may be much more concerned about an item's exposure to certain environmental conditions, and may highly value certain knowledge about historical or current exposure to environmental conditions. For example, they may pay much more for an item such as meats or produce that is certified organic GMO-free, and has had multiple aspects of its environmental conditions carefully monitored (and thus better protected from spoilage and degradation) from “farm to table”.

The present invention can help enable individuals and businesses to become aware of a multiplicity of conditions or factors that may matter to them, to ultimately trust that the items delivered and sold from a certain retailer (that may employ the inventive system at any or many parts of its logistics chain) are as fresh and unprocessed as possible, and should be acceptable to even the most highly-stringent user's needs and specifications (e.g., based on setting up user preferences and dietary/health restrictions, environmental concerns, etc.).

For businesses, many parts and specific places in their supply and manufacturing and distribution/logistics chains may allow for raw ingredients and finished goods to decompose, change consistency, or otherwise degrade or change potency, effectiveness, and/or quality of these items through exposure to certain environmental elements and conditions. Some of these environmental elements and conditions may include, but are not limited to: high levels of heat, oxygen, CO₂, humidity or sunlight; smog (or air) with molds, yeasts, or bacteria; insects or pests. Any of these elements (or many others not mentioned here) may result in goods that are less effective, more dangerous, unfit for consumption/sale, or even deadly.

Containers designed to hold liquids, foods and/or any other items, typically do not display their temperatures or any other information about any other environmental conditions (whether current or historical), and food ready to be served (such as at buffets or on shelves at retailers) also does not typically display or transmit any data about its current environmental attributes/conditions, time it was made or set out or may expire or become unsafe or unsatisfactory for consumption/use, or historical exposure to temperature changes and/or other potentially important environmental attributes/conditions that may affect perceived quality and/or satisfaction and/or value of the foodstuffs or items.

Additionally, there is almost no standardization of “date” labels for goods. For instance, “Best By”, or “Sell By”, or “Use By” are a sampling of different labels used in many markets today. Many consumers have no understanding (or, worse, a wrong understanding) of what these labels actually may mean in relation to actual spoilage or product quality.

Regarding at least some of the above issues, consumers currently have little (if any) knowledge about the particulars (including quality, safety and integrity) of any retailer's supply chain, their inventory management and quality control practices, or their sanitary conditions. A growing number of consumers would also like additional information regarding a retailer's recycling/sustainability efforts.

For a large number of different demographic and psychographic market segments, increased accessibility, visibility, and promotion or ease of providing more of the above-mentioned type of information available—and practically usable (preferably even personalized to an individual consumer's preferences)—would enable easier, better, and wiser choices, that ultimately would deliver enhanced shopping experiences, and may instill more trust and business loyalty between a consumer and a particular retailer. All of this would create more memorable, remarkable, and valuable consumer relationships that businesses could charge premium prices for and that consumers would happily pay.

### SUMMARY OF THE INVENTION

The needs remaining in the prior art are addressed by the present invention, which relates to an apparatus and system for remote sensing, monitoring, analyzing, altering, and possibly controlling of environmental attributes associated with items along the path from production to consumption and, more particularly, to an apparatus and system that may be utilized to provide additional information to both consumers and industries regarding the acceptable qualities of these items based on collected environmental attribute history.

In accordance with one aspect of the present invention, a database system is configured to maintain a history of environmental factors (e.g., one or more factors such as, but not limited to, ambient and/or internal temperature history, humidity, exposure to gasses (or molds, bacteria, viruses, toxins, etc.), barometric pressure, sunlight/UV exposure, preservatives, chemicals, etc.) associated with a specific item from its creation to its consumption (e.g., “from farm to table”). Associated with the environmental factors may also be geo-locating information and source-identifier information identifying the producer of the item, various distributors in the supply chain, and ultimate seller (e.g., local “brick and mortar” establishment, internet retailer, etc.). Individuals may gain access to this database (and perhaps analyze this data with user-specific data stored elsewhere) to enable better-informed product selection and purchases.

In another embodiment of the present invention, the collected history of items may be reviewed in conjunction with an individual's own database of items “on hand”. This database may be created, at least in part, by linking together digital or physical receipts, invoices, and/or retail shopper's card database purchases, as well as utilizing data associated with a smart appliance (e.g., intelligent refrigerator, fitness tracker, computer), or created by the individual him/herself. Indeed, the individual may scan barcodes or QR codes and provide entry of the associated information into his own “inventory” database. The combination of these sources of information may then be used by the individual to best control the supply and use of various items on hand; possibly alerting the individual and/or automatically replenishing inventory as items go beyond expiration date(s) (or any other similar dated labels or quality/freshness indicators that may be used or created in the future) and, perhaps, better managing the use of certain items to prevent waste associated with spoilage.

One exemplary, specific embodiment of the present invention takes the form of a probe monitor that may be used with items to log environmental attribute data. In one particular configuration, a temperature probe may be utilized, for example, with a liquid item or beverage (such as coffee or tea or water), or a foodstuff such as a meat being cooked, to identify an internal (and/or nearby external) temperature and/or time under heating/cooling conditions—and/or any other possibly desirable parameter that may affect an item's actual or perceived quality associated with any or all simple or advanced cooking styles and techniques—such that whenever a food or other item may be best-suited for consumption or removal from a cooking apparatus, a user may be alerted.

Another specific consumer embodiment takes the form of a “smart container”, where the sensor capabilities of the probe monitor are incorporated into a re-usable container so that an individual can monitor the conditions of certain items (such as perishable food) and track the containers so that perishable goods are consumed before they spoil.

Other and further aspects of the present invention will become apparent during the course of the following discussion and by reference to the accompanying drawings.

### BRIEF DESCRIPTION OF THE DRAWINGS

Referring now to the drawings, where like numerals represent like parts in several views:

FIG. 1 is a block diagram illustrating an exemplary network architecture useful for creating and maintaining historical information and inventories associated with goods in accordance with the present invention;

FIG. 2 illustrates an exemplary level of data-gathering that may be performed in association with the system as shown in FIG. 1;

FIG. 3 is a flowchart illustrating an exemplary set of data-gathering operations that may be performed by an exemplary sensor node in accordance with the present invention;

FIG. 4 is a flowchart illustrating an exemplary set of data-gathering operations that may be performed by an exemplary base unit, using a microprocessor located within the base unit;

FIG. 5 is a flowchart illustrating an exemplary set of data-gathering operations that may be performed at a network server, using a microprocessor located within the server;

FIG. 6 illustrates in an exploded view, an exemplary probe apparatus formed in accordance with the present invention;

FIG. 7 is a view of the integrated circuit of the probe apparatus of FIG. 6;

FIG. 8 contains three view of the inventive probe, with FIG. 8(a) showing a first temperature state, FIG. 8(b) showing a second temperature state, and FIG. 8(c) showing a third temperature state;

FIG. 9 illustrates an exemplary user device, including a display illustrating the communications between the user device and the probe of FIG. 6;

FIG. 10 is a side view of an exemplary “smart” container formed to include sensing elements and integrated circuitry in accordance with the present invention;

FIG. 11 is a top view of the exemplary “smart” container of FIG. 10; and

FIG. 12 is an interior view of the “smart” container of FIG. 10, illustrating a particular mechanism that may be used to couple together the various components forming the container.

### DETAILED DESCRIPTION

For many businesses involved in the creation and selling of goods, several potentially important environmental attributes of goods (as well as, perhaps, the several ingredients used in the creation of the goods) are not likely to be tracked or monitored. In a few cases, some distribution chains may track temperature (for example) at a rather macro level (for example, an entire warehouse room or a large shipping container in a cargo ship). This type of macro tracking may miss important details in environmental attributes that are important to the optimum quality of the perishable goods.

Some retailers are currently implementing and/or exploring the use of RFID tags and IoT (Internet of Things) technologies, but often lack compelling business cases for these expenses. Various aspects of the present invention as described in detail below are considered to be an impetus to implement these systems—by delivering much more information and benefits to every business, user and individual touched by these distribution chains (for example, tracking multiple environmental attributes of a food along the entire journey from “farm to table” or an item from a manufacturer to the end-user).

Consumers would likely relish the opportunity to understand much more information about the source/manufacturer of a good, and to understand how and when a good ended up on their retailer's shelves (at times during the following discussion, this information may be collectively referred to as the “historical path” associated with a particular good). In the case of food, this could help ensure it is as fresh and ripe and as optimal for a consumer's preferences as possible (e.g., from a preferred geographic location, and possibly even from a particular farm), and therefore may be worth a higher price since it may be better quality than other nearby supermarkets or retailers.

Businesses implementing the measuring and monitoring of environmental attributes in accordance with the present invention may better understand, and be able to optimize their supply chain and logistics partners, as well as be able to reduce wastes and costs, avoid/manage mishandling and aberrations in shipping and storage conditions, which should ultimately yield happier, more satisfied, and more loyal customer relationships, boost sales, and increase shareholder value for businesses that adopt the inventive system.

As will be discussed in detail below, one exemplary embodiment of the present invention is configured to measure temperature and other environmental attributes (e.g., humidity, pressure, gasses, and/or any other spoilage factors as noted throughout the specification) in proximity to a specific item. The measured attributes may be stored in at least one database system, which may thereafter be accessed by users/consumers and utilized in the shopping, comparison and decision-making process regarding the purchase of goods.

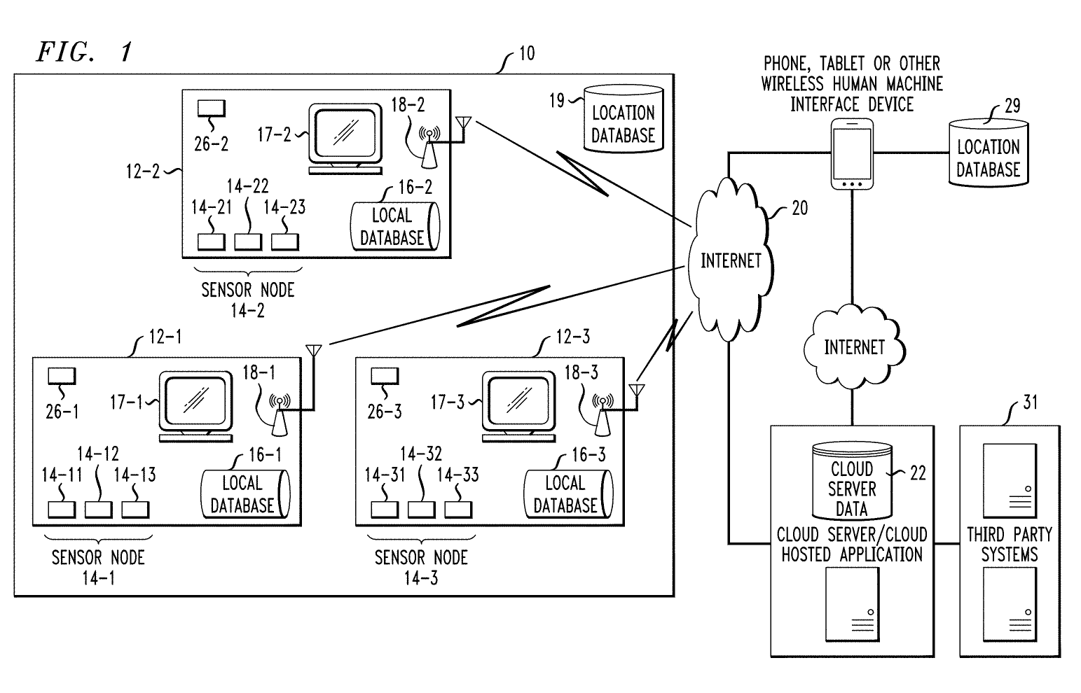

FIG. 1 is a block diagram illustrating an exemplary network architecture useful for creating and maintaining historical information and inventories associated with goods in accordance with the present invention. In this particular example, a warehouse location 10 is shown as housing three separate items 12-1, 12-2 and 12-3, each equipped with sensors and communication capabilities in accordance with the present invention. For this example, each “item” may take the form of a pallet of goods, a shipping container of goods, or any other encased quantity of certain goods. It is to be understood that an actual number of stored items is likely in the thousands—the illustration of three items is for the sake of clarity and only to explain the various attributes of the present invention.

It is also to be understood that while at times the term “perishable” may be used to refer to a selected item moving from producer to consumer, this is exemplary only. Users may choose to monitor a variety of non-perishable goods with the system of the present invention and, therefore, the scope of the invention is considered to be limited only by the claims appended to the end of the specification.

Associated with each item 12 is a plurality of sensors 14, used to measure one or more environmental attributes of that particular item 12. In one embodiment, these attributes are measured periodically and the measurements can be stored in a local database 16 associated with the specific item 12 (and/or stored at a database 19 associated with location 10). The environmental attributes measured (and, therefore, monitored) by sensors 14 may include one or more of the following: weight measurement for inventory of items in the encasement, pressure measurement for monitoring of atmospheric conditions present within the encasement, flow rates of materials to/from the encasement, turbidity sensor(s), atmospheric conditions sensor(s), “level” sensor(s), temperature data, humidity data, chemical sensor(s) to analyze either items or environmental conditions (for example, gas sensor(s) to detect the presence and/or relative amounts of ethylene, oxygen, carbon dioxide, nitrogen, smog, pesticides, volatile organic compounds, poisons, heavy metals, pharmaceuticals, food preservatives and additives, plasticides), microphone or audio sensor(s), light (or photo) sensor(s) (such as laser, infrared, UV, photographic), electromagnetic sensor(s), X-ray monitoring, electrical voltage, electrical current, electrical power, motion sensors cameras, smoke, carbon monoxide, pH sensor, barometric pressure, elevation, GPS, biological sensor(s) or any other technologies capable of detecting any types of bacteria, yeast, viruses, blood, bodily fluids, etc., illegal or pharmaceutical presence detector(s) or sensor(s), or the like. It is to be understood and noted that wherever “sensor(s)” are mentioned in the specification, these sensor(s) may be selected from any of these types as noted above.

Each item 12 may have an RFID tag (and/or any one or plurality of IoT chips, barcodes, QR codes, etc.) affixed thereto (for identification purposes) and the collected environmental attribute data can be stored on a database 16 included within the system associated with that item (and/or in location database 19 that is utilized to store data for multiple or all items in a certain area or building or location.

At given times (which can be user-defined and also modified as need be), the stored information from each database 16 (for example, databases 16-1, 16-2 and 16-3 as shown in FIG. 1) can be transmitted through a communication network and stored in an off-site database. In the particular example shown in FIG. 1, each item 12 includes a transmitter element 18 for communicating the stored information through a data network (such as internet 20) and stored in a network-accessible database 22 (in some cases, referred to as “cloud storage”) and also can direct the data to other databases or systems, such as a user's personal database 20 (that may be used, for example, to primarily track a user's items on hand at a home location) and/or a third-party system 31.

As also shown in FIG. 1, an individual may access cloud storage 22 using his/her own communication device(s) 24 (which may be a phone, tablet, computer, smartwatch, or any computing system) and retrieve information associated with a particular item 12. The retrieved information may then be used by an individual to assist in making a variety of decisions (for example, purchasing decisions comparing buying fresher, newer items or using older items being stored and monitored by the inventive system). Users may also store data within the system. For example, a user's methods for data-entry into the inventive inventory management system may include any one or several of the following methods: (1) scanning of barcode, QR code, passive RFID, active RFID; (2) automatic entry of data using proximity and automatic storage of unique network address, also through automatically-gathered telemetry data for various elements in the system; (3) direct entering of data on human-machine interface (HMI) screen, or other input device such as keyboard, mouse, etc. that may be directly attached to user apparatus, or act as a separate device; or (4) voice-to-text storage of contents (particularly appropriate for use with the “smart container” application of the present invention), whereby the user speaks an identification of the contents of the container and associated data information. Users may also acquire data from multiple third party systems/databases (such as database 31 shown in FIG. 1) to enhance knowledge and comparative abilities.

While the system as described thus far is only operating in a “passive” mode of collecting environmental attribute data and passing it along in a network for storage and use by individuals, it is also possible to utilize this collected information in a variety of “active” modes. For example, if collected temperature data associated with items stored in a particular shipping container begins to register an elevated value for all items, an alarm may be triggered. In some embodiments of the present invention, each item 12 further includes a set of process controllers 26 that are able to respond to the specific alarm condition and limit further damage. For example, the alarm may be used to automatically initiate a cooling or heating process for a container or the adjustment/release of gasses. Other types of specific elements that may be included within process controllers include, but are not limited to: valves/dampers/actuators, humidity and gas controls (including methods to affect the relative composition of certain gasses), heat pump system (e.g., Peltier, laser, resistive, etc.) for control or modification of the temperature of the stored good and/or its embodiment, transducer/piezo/laser/microwave/x-ray/EMF for changing vibration of solids, liquids, or gases present in perishable goods, “outside” of encasement conditions in terms of light, heat, humidity, pressure, etc.

Instead of incorporating controllers 26 within each item, the presence of an alarm condition may be transmitted to the proper personnel responsible for maintaining the stored goods in acceptable condition.

Another aspect of the present invention is the ability for the individual consumer to utilize the collected data to improve his/her dietetic habits, fitness level, efficiency in meal preparation, economic savings (e.g., reducing waste and spoilage). In particular, a user may create his/her own database of “items on hand” (shown as database 29 in FIG. 1), where any information stored on “smart containers” or within smart appliances or fitness tracking devices, or databases 22 or 31 (for example) may also be accessed and stored in database 29. Other information such as user preferences for certain items (or specific retailers, freshness levels, etc.), recipes, favorite grocery stores, and the like may be stored in database 29. It may also be possible to include in this system a process for altering a user when “new stock” associated with one these preferences occurs.

To ultimately improve and maximize an individual's enjoyment and economic value from the concepts of the present invention, it may be possible to use information stored in both database 29 and database 22, aggregating together the “historical path” data in database 22 with preferences and local inventory stored in database 29 (and perhaps other third-party databases 31) to derive a “best option right now” result in meal planning, grocery shopping, dietary/fitness goals, etc., which may further incorporate the preferences of the entire family for which the purchasing of goods and preparing of meals takes place. Indeed, it may be configured to utilize higher-weighted scores for the parents' desires, or children's needs, depending on user-specified conditions.

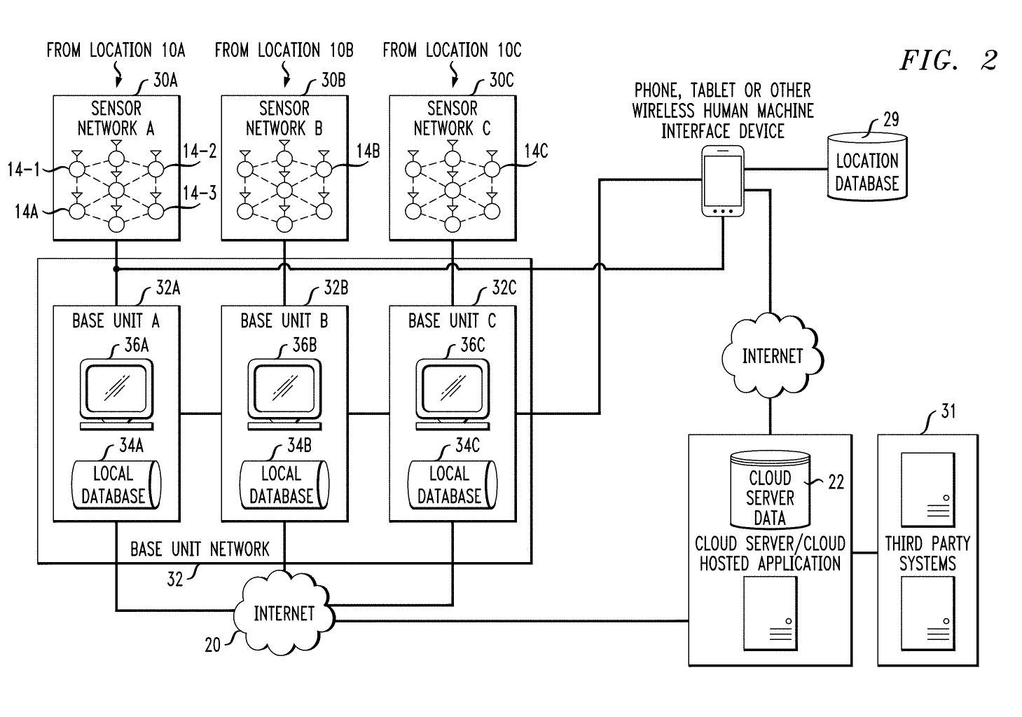

FIG. 2 illustrates an exemplary level of data-gathering that may be performed in association with the system as shown in FIG. 1. A set of sensor networks 30, each associated with a different portion of a supply chain (for example, a set of different warehouse locations, or each action point along the path from farm to table) is shown in FIG. 2. Each sensor network 30 is formed of a plurality of sensor nodes 14 in its local area. For the sake of discussion, an individual “sensor node 14” is defined as the collection of individual sensors associated with an item 12, where the individual sensors periodically gather data associated with, for example, temperature, humidity, pressure, gasses, or any other information collected by any type of sensor as mentioned above. Thus, sensor network 30A includes a plurality of sensor nodes 14A associated with items 12 stored within a warehouse 10A. For the sake of discussion, sensor network 30B includes a set of similar sensor nodes 14B and sensor network 30C a set of sensor nodes 14C.

Referring to sensor network 30A, it is shown that the various sensor nodes 14 periodically broadcasts its address information and collected data (“historical path” information which can be stored in database 16 of item 12 and/or other databases such as location database 19, network database 22, user database 29 and/or third-party database 31) to any other sensor nodes 14 in its local proximity (that is, the set of nodes 14 forming network 30A). The other sensor nodes 14 may then store a copy of this historical path information, for purposes of redundancy or other performance metrics. Similarly, commands issued to nodes or sensor networks may also be propagated in a redundant manner (e.g., network C may send a “shut off” command to item 12A through neighboring nodes or networks). Futhermore, certain data inputs or outputs may have attributes that are associated with different level of priority transmission

Each sensor node 14 may also communicate with an associated base unit 32, which stores data for all sensor nodes 14 in the local sensor network 30 within its own base unit database 34 (that is, base unit 32A stores data in a database 34A for all sensor nodes 14 in local sensor network 30A).

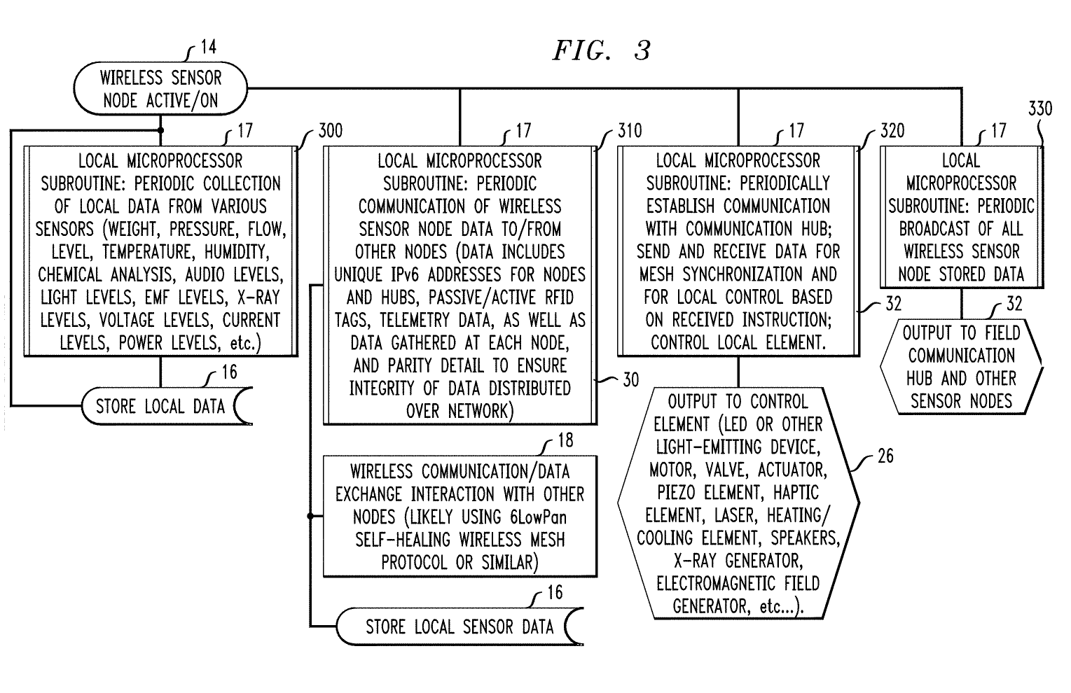

As will be described below in association with FIG. 3, base unit 32 processes subroutines (which may be performed via an included processor 36) using the data from each sensor node 14 and local sensor network 30 collectively, where base unit 32 then transmits this information to network-based storage facility 22 (as well as to other user-based devices, perhaps, and other base units and/or databases). While shown in FIG. 2 as transmitting the data over wired line communications between base units 32 and database 22 (via internet 20), in many cases “wireless” communication systems will be employed.

In some embodiments of the present invention, it may be desirable to implement what is known as a “quantum system” between the various sensors, nodes, hubs, networks, and the like. In particular, various ones of these elements may be configured to include a “quantum gate” in order to alter quantum states and translate data held in qubits to classical bits for traditional computations purposes. In this quantum system arrangement, each node, hub, network or access point may apply quantum algorithms for local and/or distribute analysis of the data being gathered. Moreover, quantum encryption techniques may be employed to ensure that the data and commands transmitted between various elements is not lost or corrupted.

In one particular configuration, a quantum channel may be established between nodes, hubs, networks, or access points for the transmission of qubits of particular entangled states to other ones of the nodes, hubs, networks or access points, to ensure secure transmission and/or integrity of data. Various qubits or quantum entangled states present across multiple established quantum (or classical) communication channels may be predicted or verified through quantum non-locality phenomena. Observation of qubits or quantum entangled states may be used for immediate verification of data collected by nodes, hubs, networks, or access points (or, alternatively, used for the correlation of data for the purposes of parity checking and immediate control of various control elements present on different components of the apparatus).

Quantum teleportation methods may be established by employing quantum entanglement or similar methods between nodes, hubs, networks, or access points to remove latency issues with communication of data to/from various other nodes, hubs, networks, or access points, such that simultaneous or near-simultaneous inputs to the system may result in simultaneous or near-simultaneous control of various apparatus and control elements.

FIG. 3 is a flowchart illustrating an exemplary set of data-gathering operations that may be performed by an exemplary sensor node 14, using a microprocessor 17 located with sensor node 14 at item 12. In particular, FIG. 3 illustrates a number of different subroutines that may be performed by sensor node 12. A first subroutine 300 initiates the periodic collection of local data from the various individual sensing elements being used (i.e., measuring temperature, pressure, humidity, etc.). The collected data is then stored in the local database 16. A second subroutine 310 initiates periodic communication of this specific sensor node 14 with the other sensor nodes of its network 30. Each sensor nodes in the network may then store data associated with other sensor nodes. A third subroutine 320 initiates the establishment of communication with the base unit 32 associated with the particular node. This communication link may allow for data to flow in both directions between the base unit and the sensor node, which may include the triggering of alarms at the sensor node. Lastly, a fourth subroutine 330 initiates a process for the sensor node to broadcast all stored data. Various other processes and subroutines may be associated with sensor node 14; those enumerated above are considered to be exemplary only.

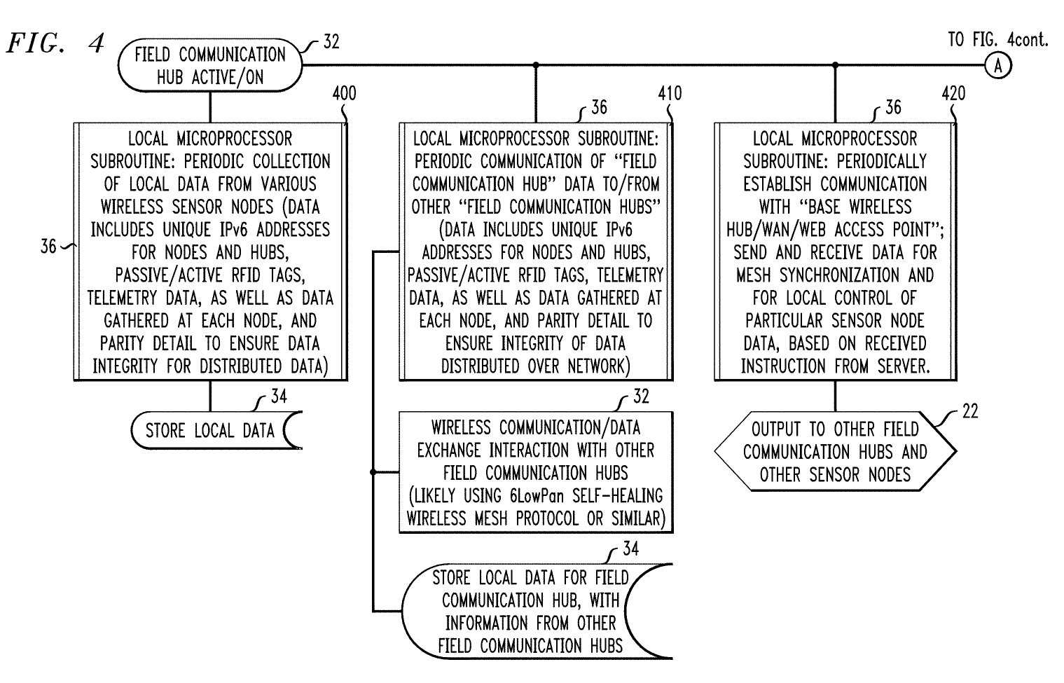

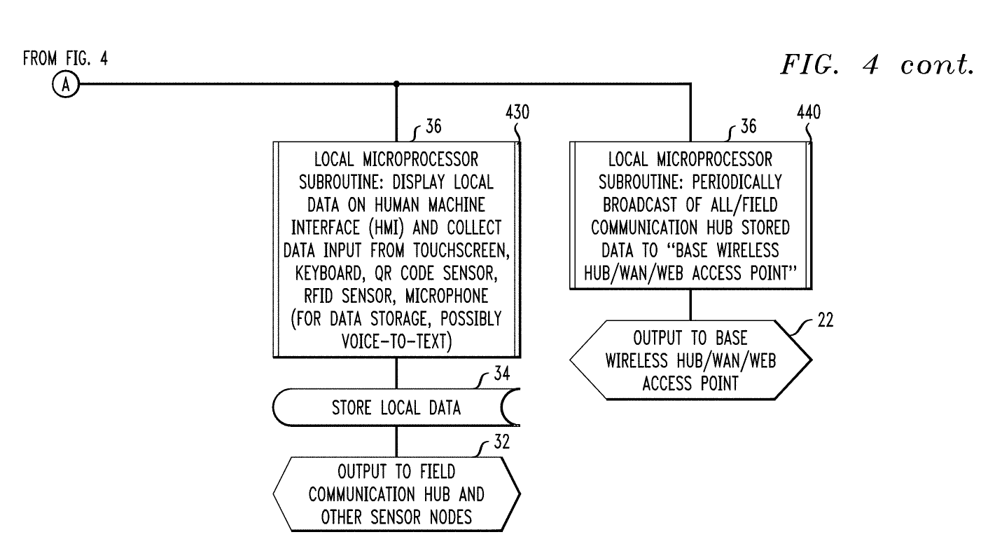

FIG. 4 is a flowchart illustrating an exemplary set of data-gathering operations that may be performed by an exemplary base unit 32, using a microprocessor 36 located within base unit 32. A first subroutine 400 initiated by microprocessor 36 involves the periodic collection of local data from each of the sensor nodes 14 in its associated sensor network 30 (as shown in FIG. 2). The collected data is then stored at database 34 resident at base unit 32. A second subroutine 410 initiates the communication of this “local” data with other base units 32 within a predetermined area, where the information collected from the other base units 32 may also be stored in local database 34 (again, this redundancy in data collection and storage is useful to prevent data errors from occurring). A third subroutine 420 is utilized to periodically perform synchronization with other base units and sensor networks. A subroutine 440 is utilized to control the display of local data on an associated HMI, as well as collect data input by an individual user (as described above). Again, any received data is stored in its local database 34. In this case, the received data is also transmitted to base station 32 and other sensor nodes. A last subroutine 440 is used to periodically broadcast all data stored in database 34 of base station 32 to all elements of the network able to communicate with base station 32.

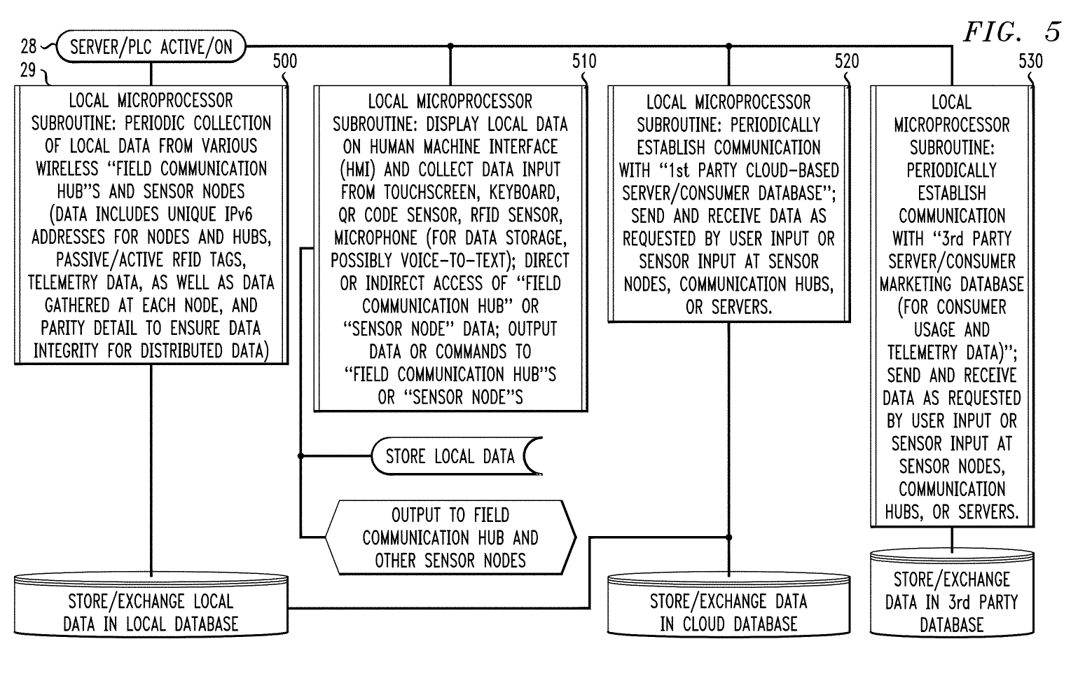

FIG. 5 is a flowchart illustrating an exemplary set of data-gathering operations that may be performed at a network server 28, using a microprocessor 29 located within server 28. A first subroutine 500 is associated with the periodic collection of local data from various base stations 32 and sensor nodes 14, which is stored in a local database 34. A second subroutine 510 allows for the display of information at server 28, as well as the collection of data input from a user (which may include controlling audio input, voice-to-text input, and the like). Subroutine 510 provides output data or commands to base stations 32 and sensor nodes 14. A third subroutine 520 initiates the periodic establishment of communication with the “local” database 34—sending and receiving data that is then stored in network database 22. Communications with any other “third party” databases 31 (for other retailers, distributors, etc.) are controlled via a fourth subroutine 530.

Data collected over a period of time may be able to be summarized from within the application (or externally through another device/website/database/interface) to provide a variety of insights, for example, about how a user's environments and cooking/eating/living habits affect their lives (i.e., this system may be especially useful to people interested in the “Quantified Self” trend, and/or who are trying to learn how to cook better at home and eat out at restaurants less). This system may help users maximize their enjoyment and safety of beverages, foodstuffs, and environments, and a variety of other items, and also save them money and time by minimizing their use of energies (both paid utilities and physiological)—for instance, by remotely alerting the user the instant that a soup has been heated to their ideal temperature on an electric/gas stovetop so they can turn it off immediately; or by alerting a user in the winter exactly when a car that was started to warm up was just warmed to the user's ideal temperature before a commute.

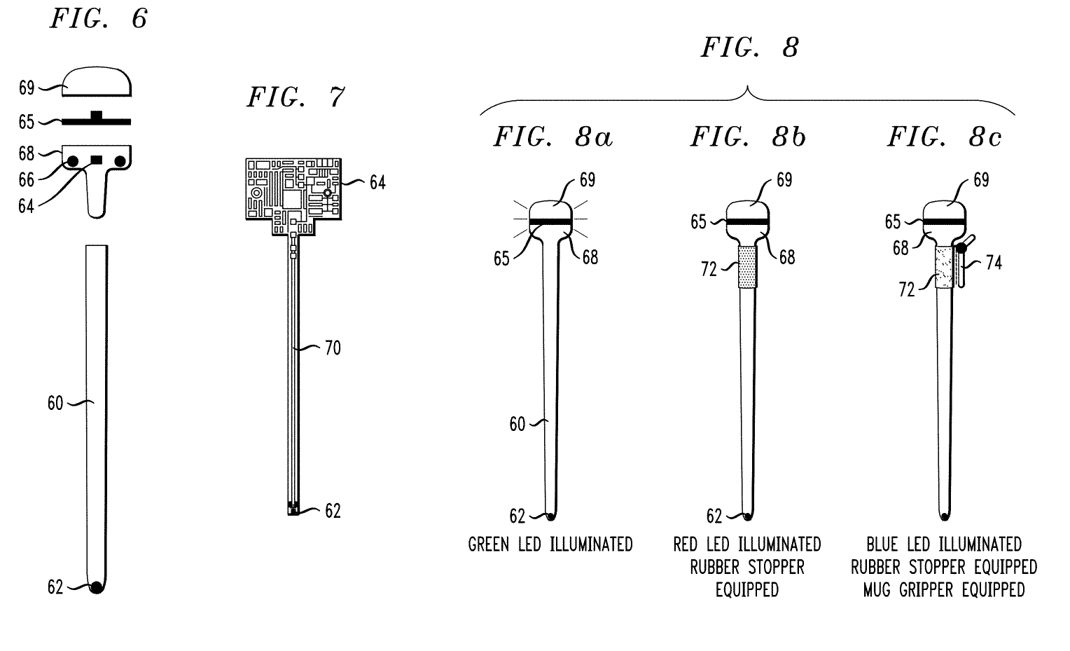

As mentioned above, the inventive system for collecting and using environmental attribute data may also be configured for use at the individual level. FIG. 6 illustrates in an exploded view, an exemplary probe 60 formed in accordance with the present invention.

Probe 60 houses the electronic connection between a measurement sensor or sensors component 62 and an associated main integrated circuit chip 64. In this particular embodiment, measurement sensor component 62 is utilized to analyze the temperature and/or other environmental attributes (perhaps via multiple environmental sensor(s) 66 described below) of the beverage/food/environment/item (hereinafter referred to as “commodity”) within which probe 60 is placed and used to send the information to main integrated circuit 64. A component housing 68 is preferably used to encapsulate and protect both measurement sensor component 62 and main integrated circuit 64, with a component cap 69 disposed over the encapsulated elements.

Main integrated circuit 64, best shown in FIG. 7, may further comprise one or more of the following components: a transmitter, a plurality of visual indicators, any one or a plurality of environmental sensors, speakers and/or means for creating ultrasonic waves (which may be used for pest control), means for creating ultraviolet waves (which may be used for sanitation), means for creating heating or cooling (such as heat pumps, peltier junctions, electronic components and means for creating and managing coolant or refrigeration capabilities, or similar technologies), a power source and an information element (such as an RFID tag and/or an IoT chip). FIG. 7 illustrates an exemplary measurement sensor component 62 (which may also be a plurality of sensors) and main integrated circuit 64 as interconnected by a plurality of electrical conductors 70 that are housed within probe 60.

FIG. 8 shows several different embodiments of the inventive probe 60, within which a light diffusing disk 65 is controlled to change color as a function of the temperature measured by sensor 62. The diagram of FIG. 8(a) indicates a “proper” drinking temperature by, for example, illuminating a green LED (not shown) that passes its light through diffusing disk 65. When a temperature measured by sensor 62 is above a desired drinking temperature, a red LED may be used to illuminate disk 65, as shown in FIG. 8(b). A drink that is below an enjoyable temperature (as measured by sensor(s) 62) may cause a blue LED to turn on, as shown in FIG. 8(c). It is to be noted that these particular color choices are exemplary only, any other type of visual/audio indicator may be used in accordance with the present invention. The specific embodiment of FIG. 8(b) also illustrates the utilization of a “stopper” element 72, which may be utilized to assist in maintaining the liquid within an associated container. The specific embodiment of FIG. 8(c) shows both stopper element 72 and a mug clip 74, which can be used to prevent the movement of probe 60 with respect to the item being monitored.

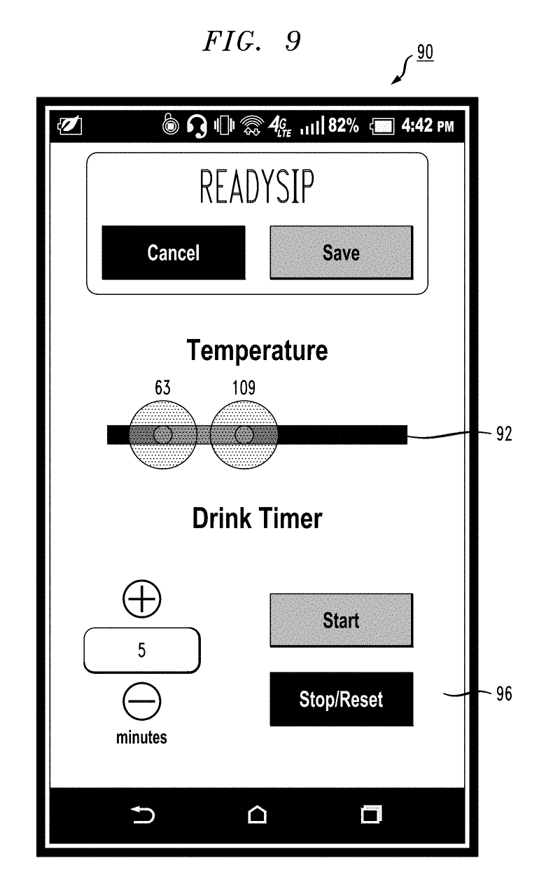

The transmitter included within integrated circuit 64 may send information back and forth between probe 60 and a user's device 90 that is capable of communication. One exemplary user device 90 is shown in FIG. 9. The information displayed may correspond to the temperature and/or other environmental attributes sensed by measurement sensor(s) 62, as well as any other information collected by environmental sensor(s) 66 (if presented).

With reference to FIG. 9, the particulars of various visual indicator(s) 92 are shown. In accordance with the present invention, visual indicator(s) 92 may display a single or multiple color(s) and/or patterns of light corresponding to the temperature and/or other environmental attributes sensed by measurement sensor(s) 62 and/or other environmental sensor(s) 66. The collected measurements are processed by main integrated circuit 64. If the temperature and/or other environmental attributes of the commodity/environment are outside of the ideal range(s), visual indicator 92 may illuminate as red. If the temperature and/or other environmental attributes falls between the high and low desired conditions (within the ideal user-selected preferred range(s)), visual indicator(s) 92 on a software application 96 and/or a visual indicator such as an LED may turn on in the probe and be seen through light-diffusing disk 65 which may turn green. If the temperature and/or other environmental attributes are below the desired low temperature, visual indicator(s) may be blue.

External user communication device 90, which may be any form of a computer, mobile phone, tablet, smartwatch, or similar technologies, may have an associated software application 96 downloaded and installed to enable the device to communication with probe 60.

In particular, software application 96 is preferably configured to receive, interpret, and analyze current temperatures and/or other environmental attributes/conditions received from probe 60 through main integrated circuit 64, including its transmitter. The particulars of software application 96 may enable the user to input the ranges of ideal temperatures and/or other environmental attributes for individual items, or to select from a menu of pre-defined ideal ranges of temperatures and/or other environmental attributes for common items (for example, rare, medium-rare, medium, medium-well, and well-done for different types of meats like beef, pork, chicken, lamb, etc.), and may also send data and alerts back to probe 60.

In one simple embodiment of the invention, probe 60 is placed into an item or place such as a prepared or raw beverage/foodstuff or environment, and may be secured by, for example stopper 72 and/or clasp/gripper/fastener feature 74, as shown in FIG. 8. Other arrangements may be used to secure probe 60 to the commodity. Through the software application, the user may be able to manually select an ideal range of temperatures and/or other environmental attributes by entering the lowest and highest settings that are preferred by them for this item/place, or the user may select from a menu of previously user-saved, and/or pre-defined safe ranges of environmental conditions (e.g., cooking temperature ranges for meats and/or common dishes/items from restaurants, etc.).

Measurements of temperatures and/or other environmental attributes may be taken periodically by probe 60, and the user may have the option to choose the rate at which each is taken. When the temperature and/or other environmental attributes are read and processed by main integrated circuit 64 at the selected rate, the conditions may be sent through its transmitter to external communication device(s) 90. In some cases, the conditions may be displayed in alphanumeric form, as shown on the exemplary device of FIG. 9. These measurement conditions may then be visually compared to predetermined ranges of ideal condition(s) the user selected on the application. Data and/or commands may be sent back from the application on external device 90 via a wireless protocol (or similar technology) to probe 60, where visual indicator(s) may display through light-diffusing disk 65 and visual indicator(s) 92 on the application may change colors and/or a display a variety of patterns which may be chosen and modified by users (for instance, red may indicate an above-ideal temperature, green may indicate an ideal temperature status, and blue may indicate a below-ideal temperature), and/or there may be additional auditory alerts or vibrations or similar types of alerting mechanisms that could also go off on other devices such as smartwatches or fitness trackers or other computers or mobile devices (or similar technologies). Whenever environmental conditions move between two statuses (for example, a temperature moves from hot/above-ideal to ideal, or ideal to cold), a user-customizable alert may be sent from the external device(s)—which may be any one or a combination of the following: a text or email message, light flash or pattern, or a sound, pop-up, application push notification, or the like.

In construction of the inventive probe, the exterior/protective elements may be injection molded, or may be formed from melting and shaping or carving/etching a variety of materials. The probe may be produced by crimping a tube of metal (or other thermally conductive material) at the end. The software application may pair/connect and transmit information to and from the apparatus through using a wireless protocol (for example, Bluetooth Low Energy or similar technologies), and the logic and code which is used by the software application may be written in a variety of programming languages for different devices and operating systems.

It is to be understood that arrangement of FIGS. 6-8 illustrate only one relatively simple exemplary embodiment of the present invention. There are contemplated to be many variations of this device, which may include a variety of sizes and shapes for the probe, as well as the component cap and component housing (which contains the bulk of the electronics). Indeed, the apparatus of the present invention may be built directly into pallets and/or shipping containers, boxes, housing containers, or the like, and be particularly useful for logistics providers. It is intended that the subject matter of the present invention may be able to integrate with and extend the functionality and localized specificity of a wide range of systems, tools, and techniques that may be used for inventory management, waste management, quality management/control, shipping and logistics, warehousing and more.

In particular, FIGS. 10-12 illustrates an exemplary “smart” container 100 which is formed to include sensing elements and integrated circuitry (including wireless communication capabilities) similar to probe 60. FIG. 10 is a simplified, cut-away side view of smart container 100, illustrating the placement of a main electrical board 110 within a base portion (for example) of container 100. In particular, main electrical board 110 may include an RF antenna, inductive charging or coupling circuitry, battery and, in some cases, active control elements (such as, for example, control valves, active heating and cooling). Various sensors utilized to measure one or more attributes, in the manner described above, may also be disposed within the base portion of container 100.

Continuing with reference to FIG. 10, container 100 is further shown as including a lid element 112. In the particular embodiment as shown in FIG. 10, lid element 112 includes a set of locking pins 114 for engaging lid element 112 with sidewalls 116 of container 100. As with the embodiment of probe 60 described above, the sensor(s) included with main electrical board 110 are utilized to measure various parameters (temperature, humidity, pressure, light, etc.), in this case defined as the “ambient environment” impacting the goods stored in container 100.

It is contemplated that in one embodiment container 100 is a consumer product, allowing the user to enter data defining the specific goods stored in the container, date information, etc., which may be used in conjunction with the collected measurements.

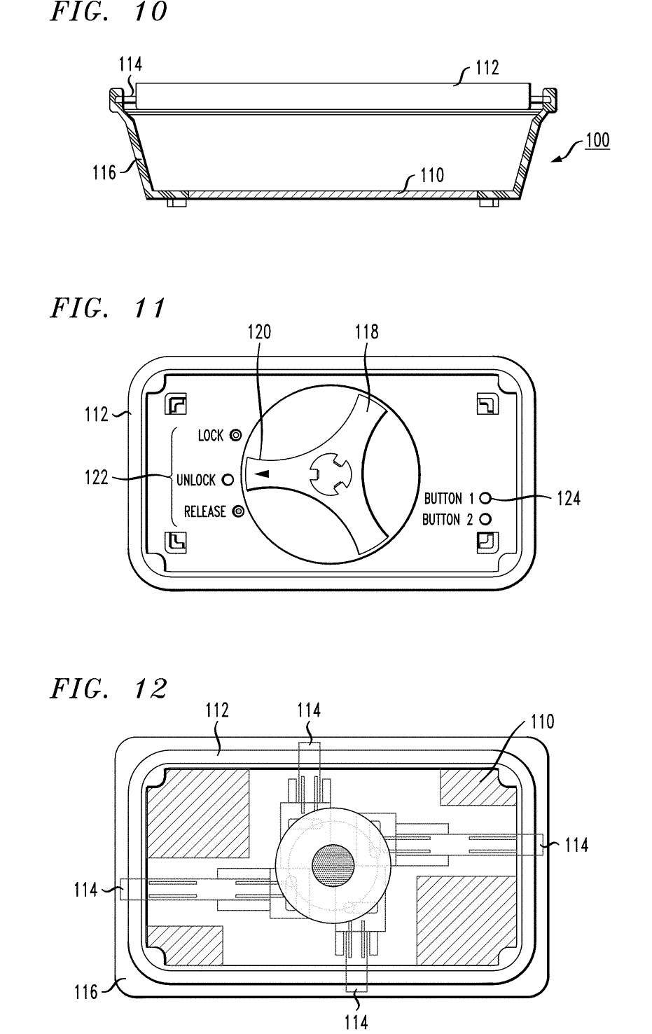

FIG. 11 is a top view of lid element 112. Shown in this view is a locking knob 118 that is connected to locking pins 114 (not shown) such that by twisting knob 118 clockwise or counterclockwise, the user can change between “lock”, “unlock” and “release” (“release” associated with the ability to remove the plastic locking components from a glass lid). An indicator 120 is included on knob 118 can be used to show the specific orientation of lid 112 with respect to container 100, with identifiers 122 showing “lock”, “unlock” and “release” disposed to align with indicator 120. Various other indicator LEDS 124 (or, perhaps even some time of HMI display) may also be included .

FIG. 12 is a cut-away view, looking down into container 100 with the glass portion of lid 112 removed. Portions of main electrical board 110 can be seen in this view, as well as portions of an exemplary mechanism for controlling locking knob 118 to move pins 114. In the view of FIG. 12, locking pins 114 are shown as fully engaged with sidewalls 116 of container 100 (i.e., the “locked” position).

An individual may thus supplement the database knowledge of perishable goods by creating his/her own database records of items stored in these smart containers. An individual is able to input data to the integrated circuit portion of the smart container to identify the particular food stored within the container, as well as the date it was prepared. As mentioned above, various techniques may be used to input this information, including keystroke input, voice command input, integration with various databases and websites, such as retailer “shopper's club” cards or membership/rewards records, purchase information such as receipts, and the like.

An additional feature of these and other consumer-based devices for sensing and monitoring environmental attributes may be configured as “active” devices, in a manner similar to some aspects of the system-based configurations described above. That is, it is contemplated that alternative embodiments of probe 60 and container 100 may include means for either heating or cooling an item in response to sensing that the temperature of the item has gone out of the range acceptable to the individual. Similar types of temperature/humidity, air or gas changes may be actively performed by a smart container, thus further extending the shelf-life of various perishable goods. Certain embodiments of the probe, container (or other structures) may also be able to hold and control the release of canisters of gasses (such as argon, CO₂, ethylene, oxygen, nitrogen, or any combination of these), which may further improve the preservation of items that may be monitored or contained within these structures.

Summarizing, the present invention includes a combination of hardware and software designed to measure, monitor, analyze, and manage beverages, foodstuffs, items, and/or environmental qualities relative to users' preferences for a variety of items. In one embodiment, the inventive system allows for a variety of remote alerting functions to help users know the optimal time to stop cooking and/or eat or drink an item, or when or whether a user should buy or use an item, or when an item or environment is a perfect match for a user's individualized criteria (for example, at a perfect temperature and/or freshly prepared or served or stocked on a retailer's shelves). This invention has multiple potential uses for consumers and commercial/industrial/agricultural users, is highly personalizable to users' preferences, and the core technology may be built into a variety of shapes and other items—for example, built into containers to store foodstuffs, or lids for items, or boxes, or pallets, or smoke or carbon monoxide detectors, or alarm systems, or “smart home” components or management/automation systems, or electronic outlets or adapters, or the like—and/or a variety of other items, and may be designed in a variety of styles to suit many brands, moods, and fashions (from subdued to conversation-starter).

In other words, the present invention may be beneficially used as a tool for consumers or commercial organizations to help in any of the following uses or instances (remotely or locally): inventory management, quality control monitoring and management, as a shopping assistant and/or research tool and/or comparison shopping engine, as a personal assistant and analytical tool to supplement data gathering efforts, goal tracking/scheduling, meal planning, time management (i.e., minimizing time on errands such as shopping, while maximizing family time and group/team satisfaction). All of this is attributable by the capabilities of the present invention to analyze different situations and data variables such as cost-benefit or value comparisons of trade-offs like using older perishable inventory before it becomes spoiled and inedible (thus wasting money). It is contemplated that the present invention may integrate and compare data and variables from numerous database sources—such as multiple websites, retailers, and search engines—and consider different weighted inputs from multiple users, and a variety of purchase/use/control options to improve decisions that may consider historical and/or present interests, needs, and goals relevant to one or multiple users' present states of mind or life/business situations.

Lastly, it is to be noted that the various examples and embodiments of the present invention as described are exemplary only. Various changes and modifications may be made to one or more elements of any of these embodiments and still considered to fall within the spirit and scope of the present invention. Indeed, the scope of the present invention is considered to be limited only by the scope of the claims appended hereto.

1. A system for monitoring environmental attributes of goods comprising
a monitoring element included with an identified good, the monitoring element including
a microprocessor for storing subroutines and controlling the operation of the monitoring clement;
one or more sensors, each sensor for measuring a different environmental attribute of the identified good;
a database for storing sensor measurements; and
a transmitter for sending stored sensor measurements to a centralized location; and
a network-based database responsive to the monitoring element transmitter for storing environmental attributes associated with the identified good.

2. The system as defined in claim I wherein the monitoring element further comprises one or more process controllers for adjusting environmental parameters in response to one or more sensor measurements.

3. The system as defined in claim 1 wherein the monitoring element transmitter comprises a wireless transmitter.

4. The system as defined in claim 1 wherein the one or more sensors include sensors selected from the group consisting of: temperature sensors, pressure sensors, humidity sensors, GPS sensors, gas sensors, an biologic sensors.

5. The system as defined in claim I wherein the monitoring element further includes an identification component associated with the identified good.

6. The system as defined in claim 5 wherein the identification component comprises an element selected from the group consisting of:
passive RFID tag, active RFID tag, barcode, QR code and IoT chips.

7. A networked system for monitoring and managing environmental attributes of a plurality of goods, the networked system including
a plurality of monitoring elements, each monitoring element associated with
an identified good in a one-to-one relationship, with each monitoring element including
a microprocessor for storing subroutines and controlling the operation of
the monitoring element;
one or more sensors, each sensor for measuring a different environmental attribute of the identified good;
a database for storing sensor measurements; and
a transmitter for sending stored sensor measurements to a centralized location; and
a network-based database for storing the plurality of sensor measurements from the plurality of monitoring elements.

8. The networked system as defined in claim 7 wherein the system further
comprises
a set of node networks, each node network associated with a group of monitoring elements; and
a base unit associate with each separate node network, where the stored sensor measurements from the group of monitoring elements are stored in a database at
the base unit, wherein the base unit is capable of communicating with other base units and the network-based database.

9. An apparatus for collecting environment. information associated with a commodity, the apparatus comprising
one or more sensors for measuring one or more environmental attributes of
the commodity;
a database for storing sensor measurements;
a microprocessor for analyzing the stored sensor measurements and monitoring conditions of the commodity; and
an indicator for providing visual/audio messages associated with the current condition of the commodity.

10. The apparatus as defined in claim 9 wherein the apparatus further comprises a transmitter for sending collected sensor measurements to another
communication device.

11. The apparatus as defined in claim 9 wherein the apparatus comprises a
probe component for insertion into the commodity.

12. The apparatus as defined in claim 9 wherein the apparatus comprises a
Container for storing the commodity, the container formed to integrate the one or more sensors, database, microprocessor and indicator into one or more portions thereof.
